(19) United States
(12) Patent Application Publication
(10) Pub. No.: US 2025/0244150 A1
(43) Pub. Date: Jul. 31, 2025

(54) DISPLACEMENT DETECTING DEVICE, AND OSCILLATOR

(71) Applicant: Mitsubishi Electric Corporation, Tokyo (JP)

(72) Inventors: Shin UEGAKI, Tokyo (JP); Yoshitaka KAJIYAMA, Tokyo (JP)

(73) Assignee: Mitsubishi Electric Corporation, Tokyo (JP)

(21) Appl. No.: 18/854,131

(22) PCT Filed: Apr. 12, 2022
(86) PCT No.: PCT/JP2022/017589

§ 371 Date: Oct. 4, 2024

(51) Int. Cl. G01D 5/241; G01B 7/14; H02K 33/00

(52) U.S. Cl. CPC G01D 5/2412; G01B 7/14; H02K 33/00

(57) ABSTRACT

A displacement detecting device includes: an insulating substrate; a graphene block in which graphene sheets each consisting of a single-layered graphene are stacked in layers; and an electrode of a conductor. The graphene block is fixed to a surface with a largest area among surfaces of the insulating substrate. The electrode is mounted on the above-mentioned surface of the insulating substrate. The above-mentioned surface of the insulating substrate is parallel to a basal plane of each of a plurality of the graphene sheets included in the graphene block. The graphene block includes a graphene flake that moves by sliding in a direction parallel to the basal plane in a case where a force having a component parallel to the basal plane is applied to the graphene block. The graphene flake is constituted of one or a plurality of the graphene sheets.

### FIELD

The present disclosure relates to a displacement detecting device, a vibrating device, and an oscillator.

### BACKGROUND

It has been confirmed that when a shear load is applied to a multilayered graphene, a graphene flake is formed by sliding at a basal plane, and when the load is removed, the graphene flake returns to the original position at a high speed. From this property, there is a possibility that graphene can be utilized as a high-frequency vibrator. However, since a graphene flake is minute, methods that can detect a behavior of the graphene flake are limited, which is an obstacle to development. One of the detection methods is a knife edge method. In the knife edge method, displacement of graphene is measured from a difference between power of an emitted laser beam and power of a reflected laser beam. The knife edge method requires a source of oscillation of the laser beam, a detector, and a plurality of lenses. Therefore, a device that implements the knife edge method has an excessively large size with respect to the graphene, and cannot take advantage of the smallness that is a characteristic of graphene.

There has been known a method of measuring displacement of a movable electrode on the basis of a variation in capacitance of a capacitor constituted of a fixed electrode and the movable electrode. In a device that implements this method, it is necessary to dispose a movable electrode perpendicularly to a substrate. Mounting graphene having a thickness ranging from nanometers to submicron sizes perpendicularly to the substrate is difficult, and applying a shear load between layers makes the graphene unstable. Therefore, displacement of graphene cannot be accurately measured.

Patent Literature 1 discloses, as a displacement measurement method, a method of measuring a variation in capacitance on the basis of a variation in area where electrodes, which are disposed in parallel to each other, face each other.

### CITATION LIST

### Patent Literature

Patent Literature 1: Japanese Patent Application Laid-open No. 2008-170402

### SUMMARY OF INVENTION

### Problem to be Solved by the Invention

However, in the method disclosed in Patent Literature 1, the electrode is mounted perpendicularly to the substrate. The multilayered graphene becomes unstable when the multilayered graphene with stacked thin films is mounted such that a basal plane is perpendicular to the substrate. Therefore, displacement of graphene cannot be accurately measured by the method disclosed in Patent Literature 1.

The present disclosure has been made in view of the above, and an object of the present disclosure is to obtain a displacement detecting device that can accurately measure displacement of graphene.

### Means to Solve the Problem

In order to solve the above-described problems and achieve the object, a displacement detecting device according to the present disclosure includes: an insulating substrate; a graphene block in which graphene sheets each consisting of a single-layered graphene are stacked in layers; and an electrode of a conductor. The graphene block is fixed to a surface with a largest area among surfaces of the insulating substrate. The electrode is mounted on the above-mentioned surface of the insulating substrate. The above-mentioned surface of the insulating substrate is parallel to a basal plane of each of a plurality of the graphene sheets included in the graphene block. The graphene block includes a graphene flake that moves by sliding in a direction parallel to the basal plane in a case where a force having a component parallel to the basal plane is applied to the graphene block. The graphene flake is constituted of one or a plurality of the graphene sheets. The electrode is mounted so that capacitance of a capacitor constituted of the electrode and the graphene flake varies according to a movement amount of the graphene flake.

### Effects of the Invention

The displacement detecting device according to the present disclosure has an effect of enabling accurate measurement of displacement of graphene.

### BRIEF DESCRIPTION OF DRAWINGS

FIG. 1 is a perspective view illustrating a configuration of a displacement detecting device according to a first embodiment.

FIG. 2 is a view for describing an example of a method of measuring a variation in capacitance.

FIG. 3 is a view illustrating a situation including two electrodes mounted on an insulating substrate.

FIG. 4 is a perspective view illustrating a configuration of a vibrating device according to a second embodiment.

FIG. 5 is a view illustrating a side surface of the vibrating device according to the second embodiment.

FIG. 6 is a perspective view illustrating a configuration of an oscillator according to a third embodiment.

FIG. 7 is a view illustrating a situation in which there are two electrodes and two stators.

### DESCRIPTION OF EMBODIMENTS

Hereinafter, a displacement detecting device, a vibrating device, and an oscillator according to embodiments will be described in detail with reference to the drawings.

### First Embodiment

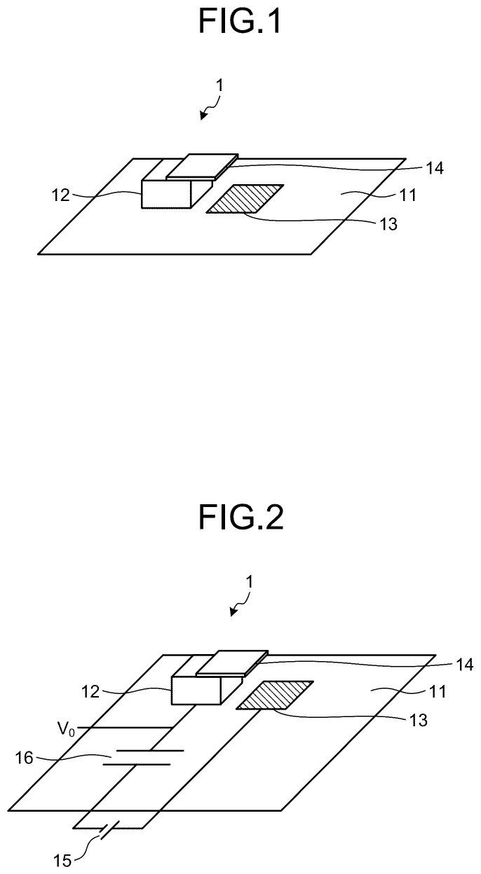

FIG. 1 is a perspective view illustrating a configuration of a displacement detecting device 1 according to a first embodiment. FIG. 1 schematically illustrates the displacement detecting device 1. As illustrated in FIG. 1, the displacement detecting device 1 includes an insulating substrate 11 and a graphene block 12 in which graphene sheets each consisting of a single-layered graphene are stacked in layers. The graphene block 12 is fixed to a surface with a largest area among surfaces of the insulating substrate 11. The displacement detecting device 1 further includes an electrode 13 of a conductor mounted on the above-mentioned surface of the insulating substrate 11.

The above-mentioned surface of the insulating substrate 11 is parallel to a basal plane of each of the plurality of graphene sheets included in the graphene block 12. The graphene block 12 includes a graphene flake 14 that moves by sliding in a direction parallel to the basal plane in a case where a force having a component parallel to the basal plane is applied to the graphene block 12. The graphene flake 14 is constituted of one or a plurality of the graphene sheets. The electrode 13 is mounted so that capacitance of a capacitor constituted of the electrode 13 and the graphene flake 14 varies according to the movement amount of the graphene flake 14.

Each of the plurality of graphene sheets included in the graphene block 12 is bonded to another contacting graphene sheet by van der Waals force. When a force including a component parallel to the basal plane of the graphene sheet is applied to the graphene block 12, a phenomenon occurs in which a certain layer within the graphene block 12 slides against another certain layer in contact with the certain layer. As a result, the graphene flake 14 constituted of one or a plurality of graphene sheets is formed. A van der Waals bond is formed at a portion where graphene block 12 and the graphene flake 14 overlap.

Since the graphene has conductivity, when the graphene flake 14 slides, a capacitor is formed by a portion of the graphene flake 14 protruding to the outside of the graphene block 12 and the electrode 13 located on the insulating substrate 11. The area where the graphene flake 14 and the electrode 13 face each other varies depending on an amount of sliding of the graphene flake 14, and the capacitance of the capacitor varies. In a case where the graphene block 12 is a square column having a square bottom surface with a side length of L (m) and the graphene flake 14 slides parallel to one side of the bottom surface of the square, the capacitance C (F) of the capacitor is expressed by the following Formula (1).

$$\begin{matrix}Formula 1 & \\ C = ε \frac{L \times x}{d} ( F ) & ( 1 )\end{matrix}$$

ε (F/m) represents a dielectric constant, d(m) represents a distance between the electrode 13 and the graphene flake 14, and x(m) represents the amount of sliding of the graphene flake 14. It is assumed that the electrode 13 is larger than the graphene flake 14, and the shadow of the graphene flake 14 projected onto the electrode 13 does not protrude outside the electrode 13.

FIG. 2 is a view for describing an example of a method of measuring a variation in capacitance. A power source 15 of voltage V (V) is connected to the graphene block 12 and the electrode 13. A capacitor 16 having a constant capacitance C_{Z} is located between the power source 15 and the graphene block 12. The power source 15, the capacitor 16, and the graphene block 12 are connected in series. By measuring potential V₀ between the graphene block 12 and the capacitor 16, the amount of sliding of the graphene flake 14 can be calculated from the following Formula (2).

$$\begin{matrix}Formula 2 & \\ x = {C}_{2} \frac{V - {V}_{0}}{{V}_{0}} \cdot \frac{d}{ε L} ( m ) & ( 2 )\end{matrix}$$

When the graphene flake 14 is formed by sliding, a new surface is created in the graphene block 12, and surface free energy U=2γLx(J) is stored in the graphene block 12. γ(J/m²) represents the surface free energy of the graphene sheet per unit area. Since a restoring force of F=2γL(N) acts on the graphene flake 14 by the stored surface free energy, when the force applied to the graphene block 12 and having a component parallel to the basal plane is removed, the graphene flake 14 spontaneously attempts to return to the original position.

As described above, the displacement detecting device 1 according to the first embodiment includes the insulating substrate 11 and the graphene block 12 in which a plurality of graphene sheets each consisting of a single-layered graphene are stacked in layers. The graphene block 12 is fixed to a surface with the largest area among the surfaces of the insulating substrate 11. The displacement detecting device 1 further includes the electrode 13 of a conductor mounted on the above-mentioned surface of the insulating substrate 11. The graphene block 12 includes the graphene flake 14 that moves by sliding in a direction parallel to the basal plane of the graphene sheet in a case where a force having a component parallel to the basal plane is applied to the graphene block 12. The graphene flake 14 is constituted of one or a plurality of the graphene sheets.

The capacitance of the capacitor constituted of the electrode 13 and the graphene flake 14 varies according to the movement amount of the graphene flake 14 due to sliding. Therefore, the displacement detecting device 1 is easily incorporated into a micro electro mechanical systems (MEMS) without the need for a huge device. Moreover, the graphene block 12 is stable as the basal plane of the graphene sheet can be fixed to the wide surface of the insulating substrate 11. Thus, the displacement detecting device 1 can accurately measure displacement of the graphene flake 14.

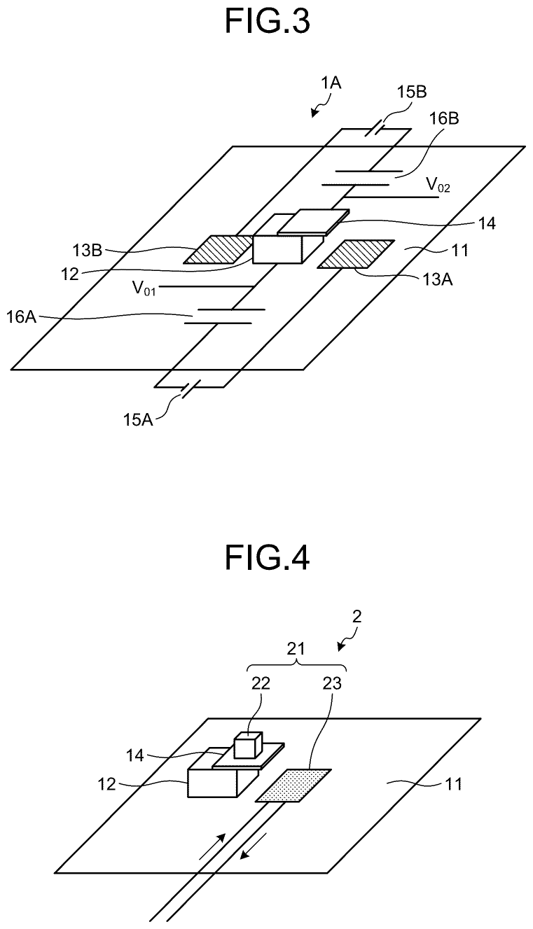

FIG. 3 is a view illustrating a situation including two electrodes 13A and 13B mounted on the insulating substrate 11. In the mode illustrated in FIG. 3, the two electrodes 13A and 13B are mounted on a surface with the largest area among the surfaces of the insulating substrate 11. Therefore, a displacement detecting device 1A can measure the amount of sliding of the graphene flake 14 in a plurality of directions by measuring a variation in capacitance of each of the two capacitors, each formed by one of the two electrodes 13A and 13B and the graphene flake 14, potential V₀₁ between the graphene block 12 and a capacitor 16A, and potential V₀₂ z between the graphene block 12 and a capacitor 16B. FIG. 3 further illustrates a power source 15A connected between the capacitor 16A and the electrode 13A and a power source 15B connected between the capacitor 16B and the electrode 13B. In a case where the two electrodes 13A and 13B are disposed with the graphene block 12 interposed therebetween, the displacement detecting device 1A is capable of measuring the amount of sliding of the graphene flake 14 at an arbitrary position on a straight line passing through the two electrodes 13A and 13B. In a case where a force with a positive and a negative that periodically alternate is applied to the graphene block 12, the displacement detecting device 1A can measure the periodic displacement of the graphene flake 14. Three or more electrodes 13 may be mounted on the surface with the largest area among the surfaces of the insulating substrate 11.

### Second Embodiment

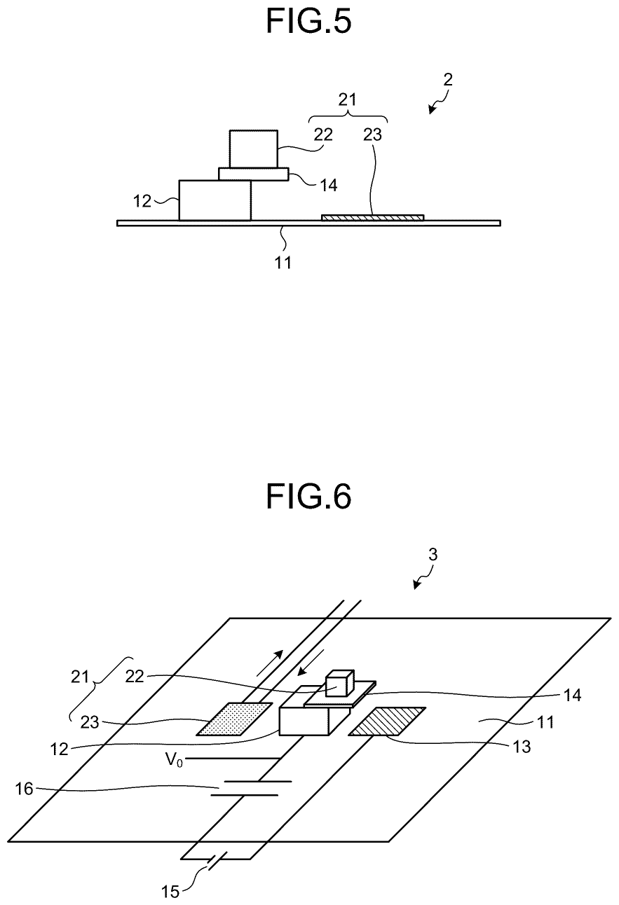

FIG. 4 is a perspective view illustrating a configuration of a vibrating device 2 according to a second embodiment. FIG. 5 is a view illustrating a side surface of the vibrating device 2 according to the second embodiment. FIGS. 4 and 5 schematically illustrate the vibrating device 2. As illustrated in FIGS. 4 and 5, the vibrating device 2 includes the insulating substrate 11 and the graphene block 12 in which graphene sheets each consisting of a single-layered graphene are stacked in layers. The graphene block 12 is fixed to a surface with the largest area among the surfaces of the insulating substrate 11. The vibrating device 2 further includes a contactless actuator 21.

The above-mentioned surface of the insulating substrate 11 is parallel to a basal plane of each of the plurality of graphene sheets included in the graphene block 12. The graphene block 12 includes the graphene flake 14 that moves by sliding in a direction parallel to the basal plane in a case where a force having a component parallel to the basal plane is applied to the graphene block 12. The graphene flake 14 is constituted of one or a plurality of the graphene sheets. The contactless actuator 21 includes a mover 22 fixed to the graphene flake 14 and a stator 23 fixed to the above-mentioned surface of the insulating substrate 11.

By inputting an externally controllable signal to the stator 23, an attractive force or a repulsive force is generated between the stator 23 and the mover 22. The force is transmitted to the graphene flake 14 on which the mover 22 is mounted, and the graphene flake 14 moves. In a case where a signal input to the stator 23 is a positive signal, an attractive force may be generated, and in a case where the signal input to the stator 23 is a negative signal, a repulsive force may be generated.

When the input signal is cut off in a state where the graphene flake 14 is displaced at the maximum, the force generated by the contactless actuator 21 disappears, and the graphene flake 14 attempts to return to the original position, but the graphene flake 14 moves to a position beyond the original position due to inertia. When a signal with an identical polarity is input to the stator 23 in a state where the difference between the position of the graphene flake 14 beyond the original position and the original position is at the maximum, the contactless actuator 21 operates again and displaces the graphene flake 14. The vibrating device 2 can vibrate the graphene flake 14 by repeating the above-described operation.

A plurality of stators 23 may be mounted on the above-mentioned surface of the insulating substrate 11, and the direction in which the graphene flake 14 moves changes depending on which stator 23 a signal is input to. In a case where two stators 23 are mounted on the above-mentioned surface of the insulating substrate 11 with the graphene block 12 interposed therebetween, it is possible to vibrate the graphene flake 14 by inputting signals with opposite phases and periodicity to the two stators 23.

For example, the mover 22 is a magnet, and the stator 23 is a coil. When a current flows through the coil, an electromagnetic force is generated, and an attractive force or a repulsive force acts between the coil and the magnet. Reversing the direction of the current changes the attractive force to the repulsive force, and the repulsive force to the attractive force. By alternating the current, the attractive force and the repulsive force are alternately generated, allowing the graphene flake 14 to vibrate.

In a case where the mass of the graphene flake 14 is minute, it is possible to vibrate the graphene flake 14 at a high frequency. For example, in a case where the graphene flake 14 is a square column flake in which each side length of the graphene flake 14 is 100 nm and the thickness of the graphene flake 14 is 3 nm, the frequency f obtained by initially displacing the graphene flake 14 by 25 nm is 1.3 GHz according to the following Formula (3).

$$\begin{matrix}Formula 3 & \\ f = \frac{1}{4} \sqrt{\frac{γ L}{{mx}_{0}}} & ( 3 )\end{matrix}$$

m(kg) represents the mass of the graphene flake 14.

### Third Embodiment

FIG. 6 is a perspective view illustrating a configuration of an oscillator 3 according to a third embodiment. FIG. 6 schematically illustrates the oscillator 3. The oscillator 3 is a device that applies the displacement detecting device 1 according to the first embodiment and the vibrating device 2 according to the second embodiment. As illustrated in FIG. 6, the oscillator 3 includes the insulating substrate 11 and the graphene block 12 in which graphene sheets each consisting of a single-layered graphene are stacked in layers. The graphene block 12 is fixed to a surface with the largest area among the surfaces of the insulating substrate 11. The oscillator 3 further includes the electrode 13 of a conductor mounted on the above-mentioned surface of the insulating substrate 11 and the contactless actuator 21.

The above-mentioned surface of the insulating substrate 11 is parallel to a basal plane of each of the plurality of graphene sheets included in the graphene block 12. The graphene block 12 includes the graphene flake 14 that moves by sliding in a direction parallel to the basal plane in a case where a force having a component parallel to the basal plane is applied to the graphene block 12. The graphene flake 14 is constituted of one or a plurality of the graphene sheets. The electrode 13 is mounted so that the capacitance of a capacitor constituted of the electrode 13 and the graphene flake 14 varies according to the movement amount of the graphene flake 14. The contactless actuator 21 includes the mover 22 fixed to the graphene flake 14 and the stator 23 fixed to the above-mentioned surface of the insulating substrate 11. For example, the mover 22 is a magnet, and the stator 23 is a coil.

The power source 15 is connected to the electrode 13 and the graphene block 12, and the capacitor 16 having a constant capacitance is disposed between the power source 15 and the graphene block 12. The power source 15, the capacitor 16, and the graphene block 12 are connected in series.

When the graphene flake 14 is vibrated by the method described in the second embodiment, the capacitance of the capacitor constituted of the graphene flake 14 and the electrode 13 periodically varies, and the potential V₀ between the graphene block 12 and the capacitor 16 periodically varies. The device illustrated in FIG. 6 can be utilized as the oscillator 3 by outputting the periodic variation of the potential V₀ to the outside as a signal. In a case where the mass of the graphene flake 14 is minute, the oscillator 3 becomes a high-frequency oscillator in a range of several gigahertz.

A plurality of electrodes 13 and a plurality of capacitors 16 may be provided. In this case, the oscillator 3 can generate different signals depending on which circuit the variation in potential is obtained from. In a case where two electrodes 13 are mounted with the graphene block 12 interposed therebetween, signals output from the two circuits each including one electrode 13 have opposite phases.

A plurality of stators 23 may be mounted. In this case, the direction of the force applied to the graphene block 12 is changed by altering the stator 23 to which the signal is input. Therefore, the direction of the displacement of the graphene flake 14 can be changed. In a case where two stators 23 are mounted with the graphene block 12 interposed therebetween, it is possible to vibrate the graphene flake 14 by inputting signals with opposite phases and periodicity to the two stators 23.

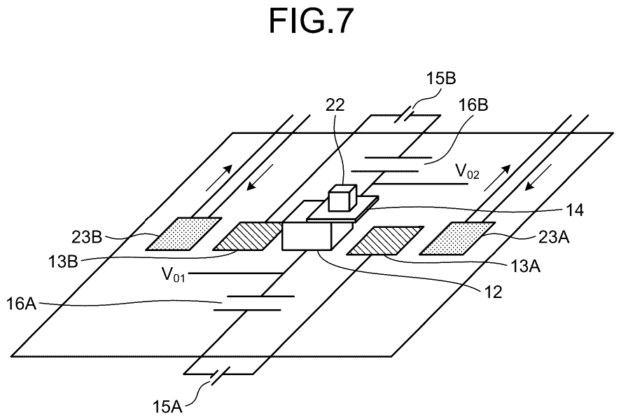

FIG. 7 is a view illustrating a situation in which there are two electrodes 13A and 13B and two stators 23A and 23B. The electrode 13A and the electrode 13B are mounted with the graphene block 12 interposed therebetween, and the stator 23A and the stator 23B are mounted with the graphene block 12 interposed therebetween. FIG. 7 also illustrates the power source 15A, the power source 15B, the capacitor 16A, the capacitor 16B, the potential V₀₁ between the graphene block 12 and the capacitor 16A, and the potential V₀₂ between the graphene block 12 and the capacitor 16B.

The configurations described in the above embodiments are just examples and can be combined with other known techniques. The embodiments can be combined with each other and the configurations can be partially omitted or changed without departing from the gist.

### REFERENCE SIGNS LIST

1, 1A displacement detecting device; 2 vibrating device; 3 oscillator; 11 insulating substrate; 12 graphene block; 13, 13A, 13B electrode; 14 graphene flake; 15, 15A, 15B power source; 16, 16A, 16B capacitor; 21 contactless actuator; 22 mover; 23, 23A, 23B stator,

1. A displacement detecting device, comprising:
an insulating substrate;
a graphene block in which graphene sheets each consisting of a single-layered graphene are stacked in layers, the graphene block being fixed to a surface with a largest area among surfaces of the insulating substrate; and
an electrode of a conductor mounted on the surface of the insulating substrate, wherein
the surface of the insulating substrate is parallel to a basal plane of each of a plurality of the graphene sheets included in the graphene block,
the graphene block includes a graphene flake to move by sliding in a direction parallel to the basal plane in a case where a force having a component parallel to the basal plane is applied to the graphene block, the graphene flake is constituted of one or a plurality of the graphene sheets, and
the electrode is mounted so that capacitance of a capacitor constituted of the electrode and the graphene flake varies according to a movement amount of the graphene flake.

2. The displacement detecting device according to claim 1, further comprising
another electrode of a conductor mounted on the surface of the insulating substrate.

3. The displacement detecting device according to claim 2, wherein
two electrodes including the electrode and the another electrode are mounted with the graphene block interposed between the two electrodes.

4.-9. (canceled)

10. An oscillator, comprising:
an insulating substrate;
a graphene block in which graphene sheets each consisting of a single-layered graphene are stacked in layers, the graphene block being fixed to a surface with a largest area among surfaces of the insulating substrate;
one or a plurality of electrodes of conductors mounted on the surface of the insulating substrate; and
a contactless actuator, wherein
the surface of the insulating substrate is parallel to a basal plane of each of a plurality of the graphene sheets included in the graphene block,
the graphene block includes a graphene flake to move by sliding in a direction parallel to the basal plane in a case where a force having a component parallel to the basal plane is applied to the graphene block, the graphene flake is constituted of one or a plurality of the graphene sheets,
the one or the plurality of electrodes are each mounted such that capacitance of a capacitor constituted of a corresponding one of the electrodes and the graphene flake varies according to a movement amount of the graphene flake, and
the contactless actuator includes:
a mover fixed to the graphene flake; and
one or a plurality of stators fixed to the surface of the insulating substrate.

11. The oscillator according to claim 10, wherein
a plurality of the electrodes are mounted on the surface of the insulating substrate, and
two electrodes of the plurality of electrodes are mounted with the graphene block interposed between the two electrodes.

12. The oscillator according to claim 10, wherein
the contactless actuator includes a plurality of the stators, and
two stators of the plurality of stators are mounted with the graphene block interposed between the two stators.

13. The oscillator according to claim 10, wherein
the mover is a magnet, and the one or the plurality of stators are each a coil.
